(19) United States
(12) Patent Application Publication
(10) Pub. No.: US 2008/0093536 A1
(43) Pub. Date: Apr. 24, 2008

(54) REDUCTION OF SOLAR INTERFERENCE IN AN INFRARED TOUCH SYSTEM

(76) Inventors: David Campbell Brower, Wake Forest, NC (US); Timothy Wayne Crockett, Raleigh, NC (US); William Lewis Talley, Wake Forest, NC (US)

Correspondence Address: DUKE W. YEE;YEE & ASSOCIATES, P.C., P.O. BOX 802333, DALLAS, TX, 75380, US

(21) Appl. No.: 11/552,371

(22) Filed: Oct. 24, 2006

(51) Int. Cl. G06M 7/00

(52) U.S. Cl. 250/221

(57) ABSTRACT

An apparatus is provided for an infrared touch system that decreases solar interference. The infrared touch system includes a mounting board, which has a number of sides that encompass an area. The infrared touch system includes a number of optical detectors and optical sources mounted along the edges on the mounting board. The optical detectors and optical sources are aligned such that a central portion of a beam pattern of each optical source is directed transversely across the opening toward one of the optical detectors so that solar interference will be decreased.

### BACKGROUND OF THE INVENTION

1. Field of the Invention

The present invention relates generally to infrared touch systems. More particularly, the present invention relates to a method and apparatus for reducing solar interference in an infrared touch system.

2. Description of the Related Art

Touch systems are typically mounted to computer displays. Infrared touch systems usually include a plurality of light emitting diodes (LEDs) arranged along two orthogonal edges of the display to emit infrared light across the face of the display. A plurality of phototransistors corresponding to the plurality of light emitting diodes is positioned along the remaining two edges of the CRT display.

To make a selection from the screen, a user contacts a region of the display, thereby breaking at least one of the light beams in each orthogonal direction forming a touch event. The phototransistors along the edges detect the broken beams. Each phototransistor corresponds to an x or y-axis coordinate. Thus, by identifying the phototransistors corresponding to the location selected by the user, the device identifies the x and y coordinates of the region of the display selected by the user. The touch event, along with its coordinate information, is communicated to the computer through a standard data input/output interface, such as RS232 or USB.

In current touch systems, the light emitting diode and phototransistor pairs face right to left and bottom to top, respectively. The phototransistors that face right to left to receive the light from light emitting diodes have been found to be susceptible to interference from sunlight when the sun is at an angle less than twenty degrees from the horizon.

### BRIEF SUMMARY OF THE INVENTION

The illustrative embodiments provide for an infrared touch system that decreases solar interference. The illustrative embodiments include a mounting board, which has a number of sides that encompass an area. The illustrative embodiments include a number of optical detectors and optical sources mounted along the edges on the mounting board. The optical detectors and optical sources of the illustrative embodiments are aligned such that a central portion of a beam pattern of each optical source is directed transversely across the opening toward one of the optical detectors so that solar interference will be decreased.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a diagram of a design system in accordance with an illustrative embodiment;

FIG. 2 illustrates an infrared grid from a known infrared touch system;

FIG. 3 illustrates solar inference with a phototransistor in accordance with an illustrative embodiment;

FIG. 4 illustrates an exemplary repositioning of an infrared grid component in accordance with an illustrative embodiment; and

FIG. 5 illustrates an arrangement of the components of an infrared touch system grid in order to reduce solar interference in accordance with an illustrative embodiment.

### DETAILED DESCRIPTION OF THE INVENTION

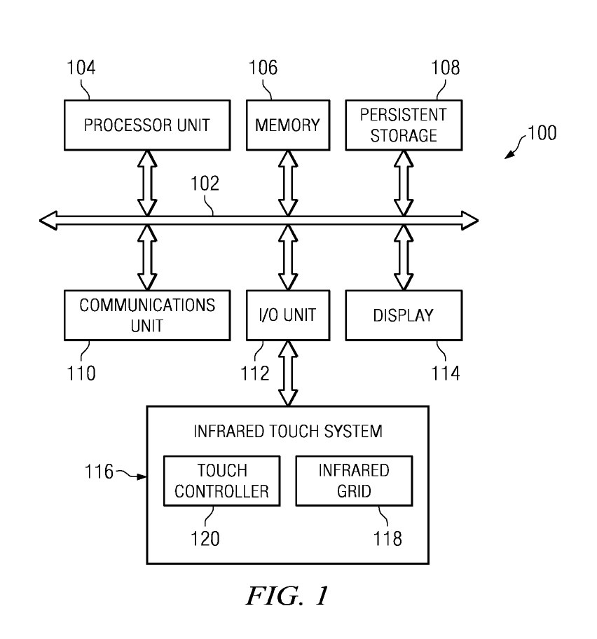

The illustrative embodiments provide for reducing solar interference in an infrared touch system through the control of the orientation of phototransistors. Turning now to FIG. 1, a diagram of a design system is depicted in accordance with an illustrative embodiment. In this illustrative example, data processing system 100 includes communications fabric 102, that provides communications between processor unit 104, memory 106, persistent storage 108, communications unit 110, I/O unit 112, display 114, and infrared touch system 116.

Processor unit 104 serves to execute instructions for software that may be loaded into memory 106. Processor unit 104 may be a set of one or more processors or may be a multi-processor core, depending on the particular implementation. Further, processor unit 104 may be implemented using one or more heterogeneous processor systems in which a main processor is present with secondary processors on a single chip. Memory 106, in these examples, may be, for example, a random access memory. Persistent storage 108 may take various forms depending on the particular implementation. For example, persistent storage 108 may be, for example, a hard drive, a flash memory, a rewritable optical disk, a rewritable magnetic tape, or some combination of the above.

Communications unit 110, in these examples, provides communications with other data processing systems or devices. In these examples, communications unit 110 is a network interface card. I/O unit 112 allows for input and output of data with other devices that may be connected to data processing system 100. For example, I/O unit 112 may provide a connection for user input though a keyboard and mouse or touch screen. Further, I/O unit 112 may send output to a printer. Display 114 provides a mechanism to display information to a user. Display 114 may also provide for the attachment of infrared touch system 116, which includes infrared grid 118 and touch controller 120.

Infrared touch system 116, which may be standalone or attached to display 114, allows a user to make a selection from the screen through contacting a region within infrared touch system 116, thereby breaking at least one of the light beams in each orthogonal direction of infrared grid 118. Infrared grid 118 may include light emitting diodes, or other optical sources, that emit light beams and phototransistors, or other optical detectors, along the edges that detect the broken beams. Each phototransistor corresponds to an x or y-axis coordinate. When a user breaks at least one of the light beams in infrared grid 118, the coordinates are sent to touch controller 120, and a location is identified by identifying the phototransistors corresponding to the location selected by the user. Touch controller 120 identifies the x and y coordinates of the region of the display selected by the user. Touch controller 120 uses a transformation equation to convert the transverse infrared reference frame to a reference frame aligned to the display. The transformation equation may be a linear transformation or change-of-base transformation. Then, touch controller 120 sends this information to I/O unit 112 using data packets similar to the data packets that are received by a mouse.

Instructions for the operating system, the object-oriented programming system, and applications or programs are located on persistent storage 108. These instructions may be loaded into memory 106 for execution by processor unit 104. The processes of the different embodiments may be performed by processor unit 104 using computer implemented instructions, which may be located in a memory, such as memory 106.

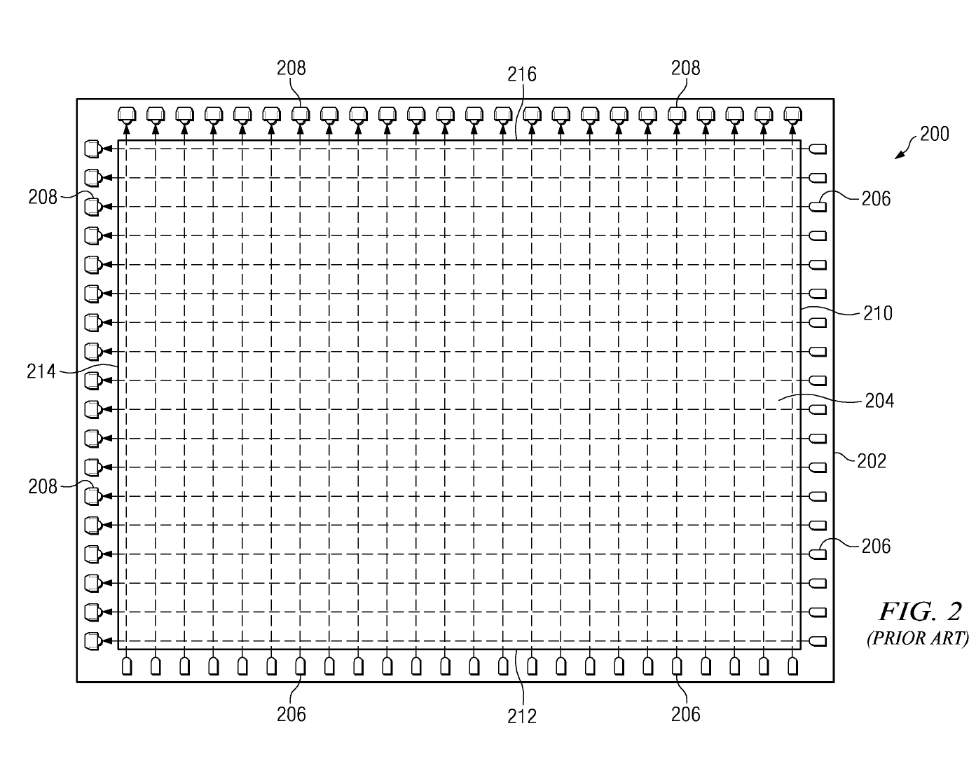

FIG. 2 illustrates an infrared grid from a known infrared touch system. Infrared touch system 200 may be part of a display, such as display 114 of FIG. 1. Infrared touch system 200 includes mounting board 202, display opening 204, light emitting diodes 206, and phototransistors 208. On mounting board 202, light emitting diodes 206 are mounted along right (display's left) edge 210 and bottom edge 212. Light emitting diodes 206 emit light transversely across display opening 204 toward phototransistors 208. Phototransistors 208 are mounted along left (display's right) edge 214 and top edge 216. Each of phototransistors 208 is oriented to receive light emitted from light emitting diodes 206.

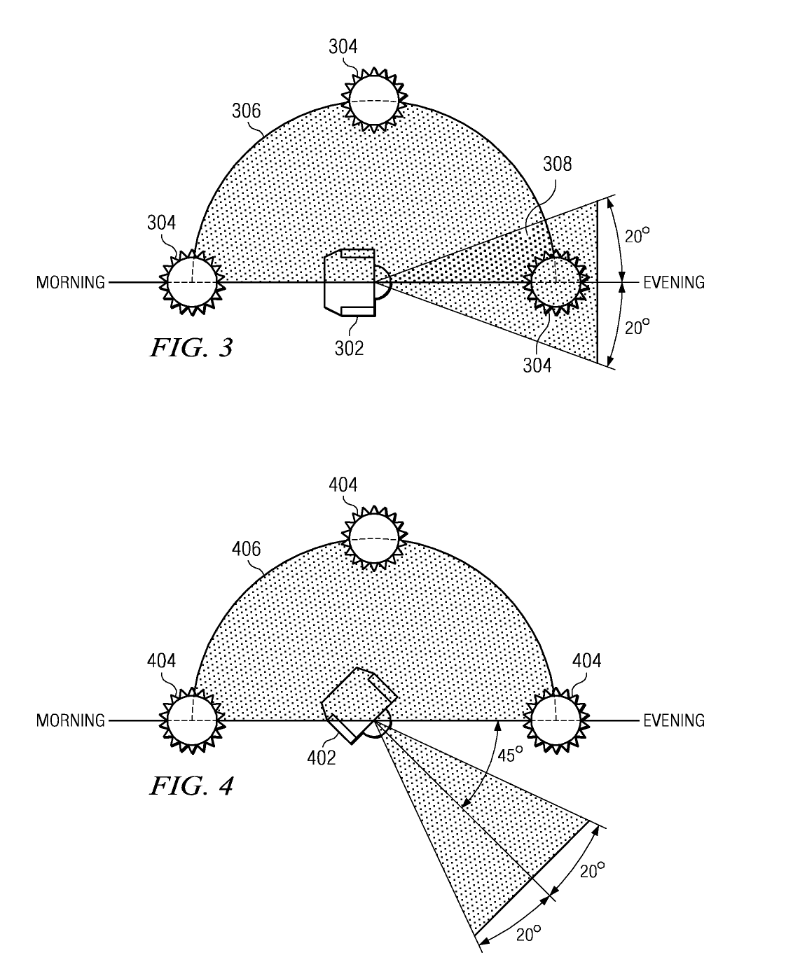

FIG. 3 illustrates solar interference with a phototransistor in accordance with an illustrative embodiment. Phototransistor 302 may be one of a number of phototransistors, such as phototransistors 208 of FIG. 2. In FIG. 3, phototransistor 302 has a reception angle around 40 degrees directed towards the horizon at 180 degrees or at 0 degrees (not shown), approximately 20 degrees above the horizon and approximately 20 degrees below the horizon. The degrees shown are for purposes of illustration, and phototransistor 302 may have other angles where solar interference may occur. Also, there may be other sources that may cause interference with phototransistor 302, such as artificial light. As sun 304 moves along path 306, phototransistor 302 experiences solar interference in the evening when sun 304 moves within solar interference region 308, which corresponds to a sensitive angle of 20 degrees above the horizon. While the illustrative embodiment shows phototransistor 302 facing to the right at 180 degrees, phototransistor 302 may also be facing to the left at 0 degrees depending on how a user orients a display. Thus, the user could also experience solar interference in the morning when sun 304 moves within an opposite solar interference region (not shown), which corresponds to a sensitive angle of ±20 degrees in the opposite direction.

To overcome the solar interference, the illustrative embodiments reposition the infrared grid so that there are no phototransistors facing the sunlight. FIG. 4 illustrates an exemplary repositioning of an infrared grid component in accordance with an illustrative embodiment. Phototransistor 402 may be one of a number of phototransistors, such as phototransistors 208 of FIG. 2. In FIG. 4, phototransistor 402 may be rotated so that the sensitive angle of ±20 degrees does not intersect with the solar angle. The illustrative embodiments show that phototransistor 402 is positioned at 215 degrees. While phototransistor 402 is shown to be positioned at 215 degrees, phototransistor 402 may be positioned at any angle that allows operation and prevents solar interference. In this example, phototransistor 402 has a reception angle of 40 degrees. As sun 404 moves along path 406, phototransistor 402 does not experience any solar interference with the sun. The degrees shown are for purposes of illustration, and phototransistor 402 may be positioned at other angles so that solar interference will be decreased.

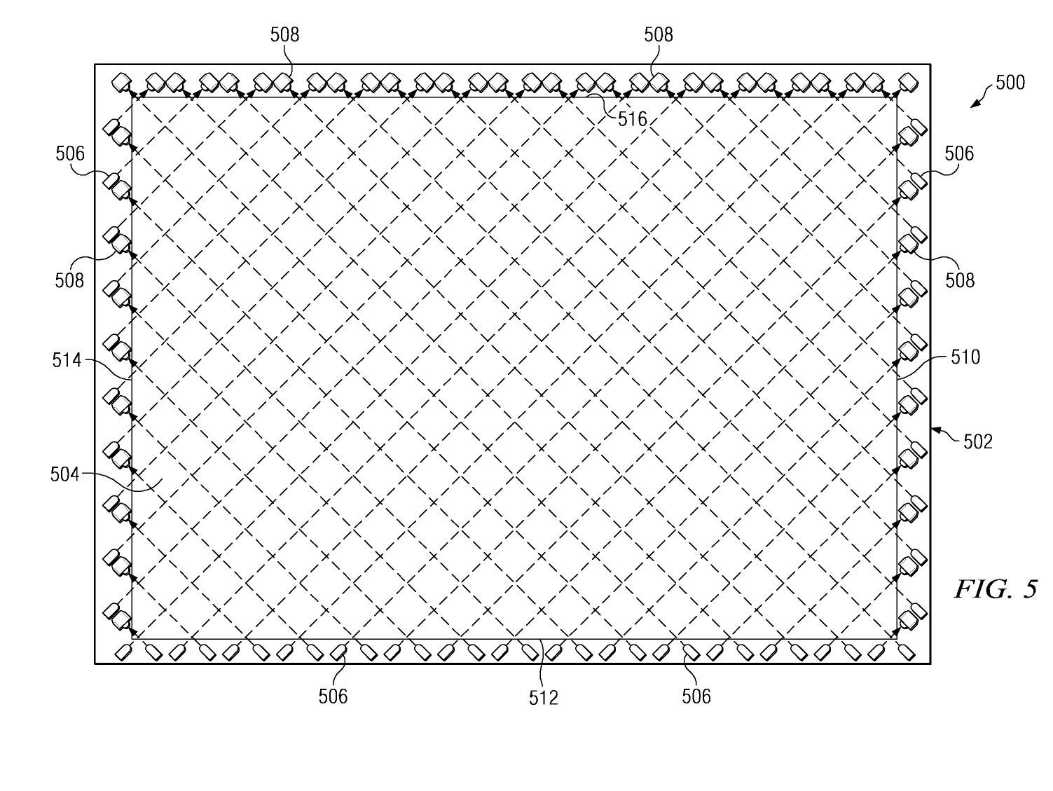

FIG. 5 illustrates an arrangement of the components of an infrared touch system grid in order to reduce solar interference in accordance with an illustrative embodiment. Infrared touch system 500 may be part of a display, such as display 114 of FIG. 1. Infrared touch system 500 is comprised of mounting board 502, display opening 504, light emitting diodes 506, and phototransistors 508. On mounting board 502, light emitting diodes 506 are mounted along right edge 510, bottom edge 512, and left edge 514. Light emitting diodes 506 emit light transversely across display opening 504 toward phototransistors 508. Phototransistors 508 are mounted along right edge 510, left edge 514, and top edge 516. Each of phototransistors 508 is oriented to receive light emitted from one of light emitting diodes 506. As an exemplary aspect of the illustrative embodiments, light emitting diodes 506 are positioned at 45 degrees or 135 degrees, and phototransistors 508 are positioned at 215 degrees or 315 degrees. The position of light emitting diodes 506 and phototransistors 508 is dependent on the sensitivity of phototransistors 508, which may be as great as ±20 degrees. While phototransistors 508 are shown to be positioned at 215 degrees and 315 degrees, phototransistors 508 may be positioned at any angle within 201 degrees to 339 degrees. While light emitting diodes 506 are shown to be positioned at 45 degrees and 135 degrees, light emitting diodes 506 may be positioned at any angle within 21 degrees to 159 degrees.

Thus, the illustrative embodiments provide for an infrared touch system that has a mounting board with a number of sides that encompasses an area. A number of optical detectors and a number of optical sources are mounted along the edges on the mounting board. The optical sources are aligned such that a central portion of a beam pattern is directed transversely across the display opening toward one of the optical detectors. The optical detectors and the optical sources are positioned at specific angles so that solar interference will be decreased.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. An infrared touch system comprising:
a mounting board having four sides interconnected in a substantially rectangular configuration, wherein the mounting board has a size and a shape selected to allow the four sides to be positioned along respective edges of an opening positioned between the four sides;
a plurality of optical detectors mounted along a first plurality of the edges, including two opposite edges, on the mounting board adjacent to the opening, wherein the plurality of optical detectors are mounted at one of a first angle or a second angle to reduce interference; and
a plurality of optical sources mounted along a second plurality of the edges, including two opposite edges, on the mounting board adjacent to the opening, wherein the plurality of optical sources are mounted at one of a third angle and a fourth angle, wherein each of the plurality of optical sources has a predetermined beam pattern, wherein each of the plurality of optical sources is aligned with a corresponding optical detector on an adjacent edge of the plurality of edges, and wherein each of the plurality of optical sources is aligned such that a central portion of a beam pattern of each optical source in the plurality of optical sources is directed transversely across the opening toward one of the plurality of optical detectors so that solar interference will be decreased.

2. The infrared touch system of claim 1, wherein the plurality of optical detectors are phototransistors.

3. The infrared touch system of claim 1, wherein the plurality of optical sources are light emitting diodes.

4. The infrared touch system of claim 1, wherein the first angle is an angle of 21 degrees to 89 degrees.

5. The infrared touch system of claim 1, wherein the second angle is an angle of 91 degrees to 159 degrees.

6. The infrared touch system of claim 1, wherein the third angle is an angle of 201 degrees to 269 degrees.

7. The infrared touch system of claim 1, wherein the fourth angle is an angle of 271 degrees to 339 degrees.

8. The infrared touch system of claim 1, wherein the opening is a display opening.

9. An infrared touch system comprising:
a mounting board having a plurality of sides encompassing an area, wherein the mounting board has a size and a shape selected to allow the plurality of sides to be positioned along edges of an opening positioned within the plurality of sides;
a plurality of optical detectors mounted along the edges, including two opposite edges, on the mounting board, wherein the plurality of optical detectors are mounted at one of a first angle or a second angle to reduce interference; and
a plurality of optical sources mounted along the edges, including two opposite edges, on the mounting board, wherein the plurality of optical sources are mounted at one of a third angle and a fourth angle, wherein each of the plurality of optical sources has a predetermined beam pattern, wherein each of the plurality of optical sources is aligned with a corresponding optical detector on an adjacent edge of the edges, and wherein each of the plurality of optical sources is aligned such that a central portion of a beam pattern of each optical source in the plurality of optical sources is directed transversely across the opening toward one of the plurality of optical detectors so that solar interference will be decreased.

10. The infrared touch system of claim 9, wherein the plurality of optical detectors are phototransistors.

11. The infrared touch system of claim 9, wherein the plurality of optical sources are light emitting diodes.

12. The infrared touch system of claim 9, wherein the first angle is an angle of 21 degrees to 89 degrees.

13. The infrared touch system of claim 9, wherein the second angle is an angle of 91 degrees to 159 degrees.

14. The infrared touch system of claim 9, wherein the third angle is an angle of 201 degrees to 269 degrees.

15. The infrared touch system of claim 9, wherein the fourth angle is an angle of 271 degrees to 339 degrees.

16. The infrared touch system of claim 9, wherein the opening is a display opening.
